(19) United States
(12) Patent Application Publication
(10) Pub. No.: US 2025/0200448 A1
(43) Pub. Date: Jun. 19, 2025

(54) SYSTEM FOR OPTIMIZING CONSUMER CHOICES USING ARTIFICIAL INTELLIGENCE ANALYSIS OF CROWDSOURCED PERFORMANCE METRICS

(71) Applicants: Dwight Harris, JR., Easton, PA (US); Santosh Kotnis, Easton, PA (US)

(72) Inventors: Dwight Harris, JR., Easton, PA (US); Santosh Kotnis, Easton, PA (US)

(21) Appl. No.: 18/790,419

(22) Filed: Jul. 31, 2024

Related U.S. Application Data
(63) Continuation-in-part of application No. 18/639,918, filed on Apr. 18, 2024.
(60) Provisional application No. 63/610,431, filed on Dec. 15, 2023.

(51) Int. Cl. G06Q 10/02; G06Q 10/0639; G06Q 30/0207; G06Q 30/0282

(52) U.S. Cl. CPC G06Q 10/02; G06Q 10/06393; G06Q 30/0239; G06Q 30/0282

(57) ABSTRACT

A system and method for optimized airline selection in air travel bookings provides a comprehensive solution for enhancing user experience in choosing airlines. This system integrates an AI-driven web platform, communicably coupled with a database, which analyzes crowdsourced consumer input on airline service experiences across multiple metrics. A user interface of the platform enables users to submit feedback and view a public dashboard of airline evaluations. The AI system processes this data to generate and update performance assessments for airlines, aiding users in making informed decisions. Additionally, the system facilitates the selection and booking of air travel, optimizing the process through up-to-date performance assessments and user preferences, including using a virtual assistant to help with the selection and booking process. The system is industry-agnostic and adaptable to various applications beyond air travel.

### BACKGROUND

### 1. Field of the Invention

The present invention relates generally to providing and facilitating choices to consumers for purchase, and more specifically to a system and method for optimizing consumer purchase choices using the example of airline selections for air travel bookings.

### 2. Description of Related Art

Computer systems allowing consumers the ability to search through available goods or services are well known in the art. Typically, websites are provided that collect, and list available options for consumers to pursue and select the options that best fit their desired choice parameters. In addition, rudimentary artificial intelligence systems are well known in the art, and have been utilized to aide in the collection and organization of the collected choices. Further, voice recognition technology has been developed that allow consumers to provide vocal input to computers for translation into computer/software commands or prompt responses.

For example, air travel booking systems are well known in the art and are effective means to facilitate flight reservations and purchases. The process of booking flights for air travel has traditionally been done using travel agents as intermediaries or directly with the airline itself. With the advent of modern technology, this process has evolved substantially, allowing for automated booking through online travel websites and mobile applications. Moreover, the rise of smartphones and virtual assistants has further advanced this evolution.

However, despite technological advancements, the air travel booking process can still become a time-consuming and often frustrating process for many consumers. Current technology in booking platforms typically lacks comprehensive evaluation and comparison of airlines based on important factors such as on-time performance, cancellations, baggage handling, and speed of refund processing. This limitation often results in users making uninformed decisions about which airline to choose, potentially leading to unsatisfactory travel experiences. Moreover, the sifting of these choices is often limited to consumers manually searching through lists of available options through manual input, and often require multiple iterations of search refinement.

Accordingly, although great strides have been made in the area of digital booking systems, many shortcomings remain. It is therefore an object of the present invention to provide a system and method that utilizes artificial intelligence (AI) to analyze crowdsourced consumer input relating to air travel experiences and thereby dynamically adjust airline evaluations and offerings, optimizing airline selection for users based on comparison of objective performance metrics for various airlines, and moreover linking this AI capability to voice recognition functionality for easier input, search adjustment, and selection choice more effectively providing a multi-step, iterative process. It should be noted that, while the present disclosure is focused primarily on airline booking, the invention presented herein should be understood to be readily adaptable to other industries and application.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a general diagram illustrating a preferred embodiment of the system of the present application;

FIG. 2 depicts a general process flow of a consumer's interaction with the present invention to book air travel;

FIG. 3 is an illustration of the process of using a virtual assistant to book flights through the system of the present application;

FIG. 4 is an exemplary user interface for reporting an airline issue;

FIG. 5 is an exemplary user interface for reporting an airline issue;

FIG. 6 is an exemplary public dashboard displaying performance rankings for various airlines on various user experience metrics;

FIG. 7 is an exemplary dashboard for displaying real-time airport issues;

FIG. 8 is an exemplary interface for viewing specific information about flight delays;

FIG. 9 is a general process flow for booking a new air travel ticket through the system of the present application;

FIG. 10 is a general process flow for adjusting an existing ticket through the system of the present application;

FIG. 11 is a flow diagram depicting the general method of the present application.

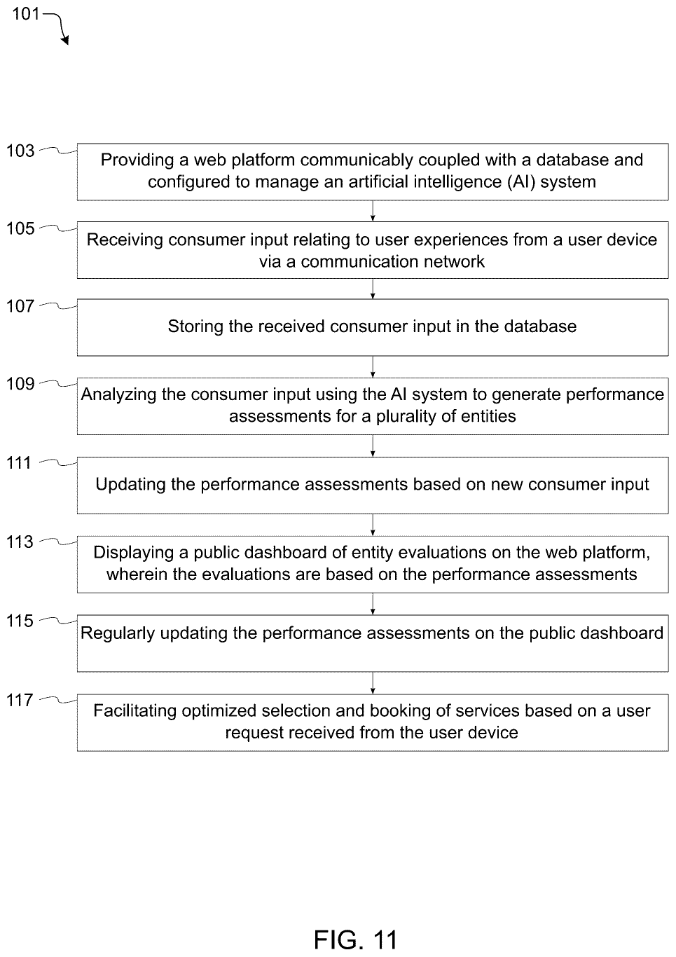

FIG. 12 is a flow diagram depicting a specific process flow for general booking in an embodiment of the present invention;

FIG. 13 is a continuation of FIG. 12;

FIG. 14 is a flow diagram depicting a specific process flow for processing adjustments to existing bookings in an embodiment of the present invention;

FIG. 15 is a flow diagram depicting a specific process flow for processing booking cancellations by passengers in an embodiment of the present invention;

FIG. 16 is a flow diagram depicting a specific process flow for processing booking cancellations by airlines in an embodiment of the present invention; and

FIG. 17 is a flow diagram depicting a specific process flow for communicating delays and other booking changes in an embodiment of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional air travel booking systems. Specifically, the system and method of the present invention analyze crowdsourced airline evaluation data using an artificial intelligence (AI) system to generate up to date airline performance assessments, facilitating informed decision making. Additionally, the system and method incorporate AI voice recognition to receive user input, even multiple iterative steps of AI guided input, and refine the booking process according to user preferences. These and other unique features of the system and method of use are discussed below and illustrated in the accompanying drawings.

Further, it should be understood that while the current implementation of the system and method are primarily directed toward airline booking, the underlying conceptual structure is industry-agnostic and widely adaptable across a variety of other industries and specific implementations.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

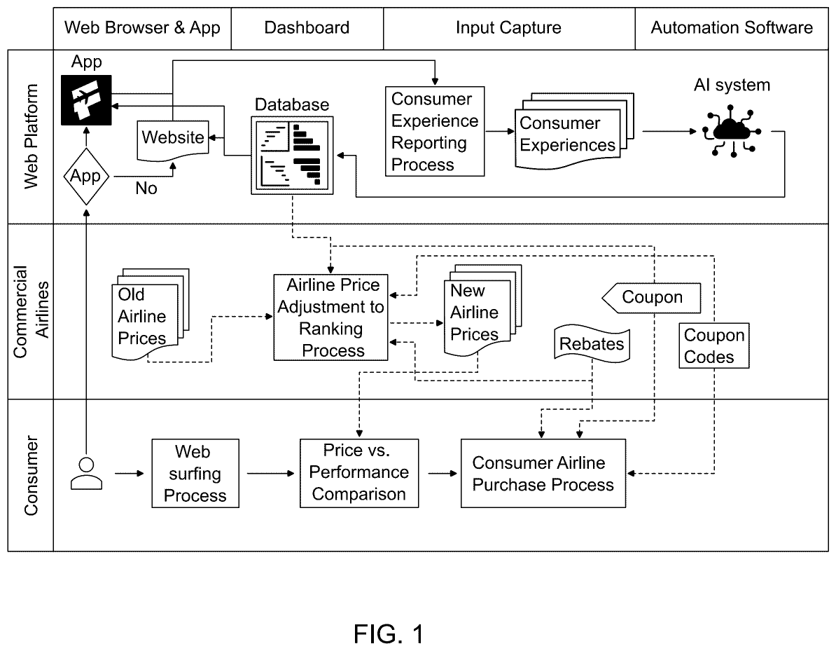

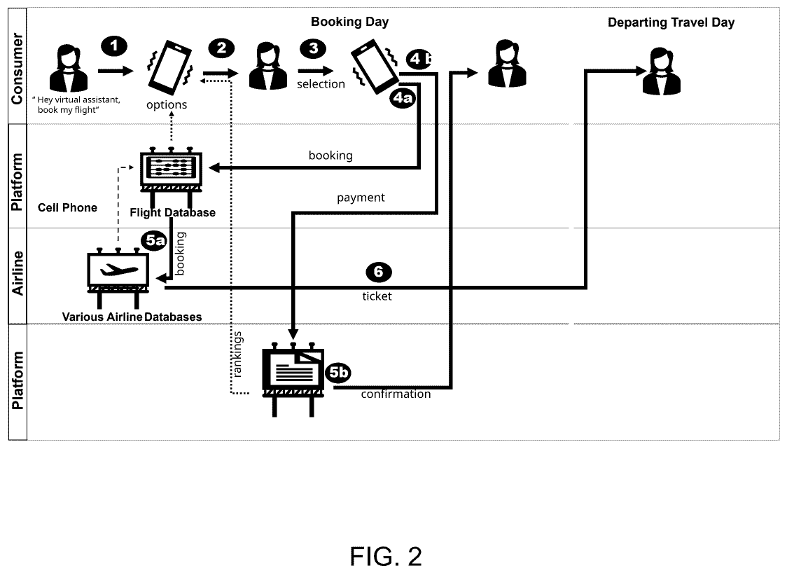

Referring now to the drawings wherein like reference characters identify corresponding or similar elements throughout the several views, FIG. 1 depicts a general diagram of a system for optimizing airline selection for air travel bookings in accordance with a preferred embodiment of the present application. FIG. 2 further depicts a general process flow of a consumer's interaction with the present invention to book air travel. It will be appreciated that the system overcomes one or more of the above-listed problems commonly associated with conventional air travel booking systems. In addition, it should be appreciated that more or fewer of such components may be included in different embodiments of the system and method.

In the contemplated embodiment, the system of the present invention includes a web platform that is communicably coupled with a database. The web platform is further configured to manage an AI system, which is central in the present invention for computational, analytical, and generative tasks related to airline service experiences.

The web platform comprises a user interface that is accessible to a user from a user device through a communication network, such as, but not limited to, the Internet, a cellular communication network, Wi-Fi networks, and the like. Throughout the present disclosure, a singular user is referred to as an exemplary case considered generally applicable to many other users. The user interface may be understood in the present disclosure to correspond to, but is not limited to, an Internet website frontend for the web platform.

Alternatively or additionally, the present invention may further be realized in various embodiments as a mobile software application installed on a smartphone, or user device associated with the user. The web platform and mobile application should offer the same functionalities and rely on the same data repositories.

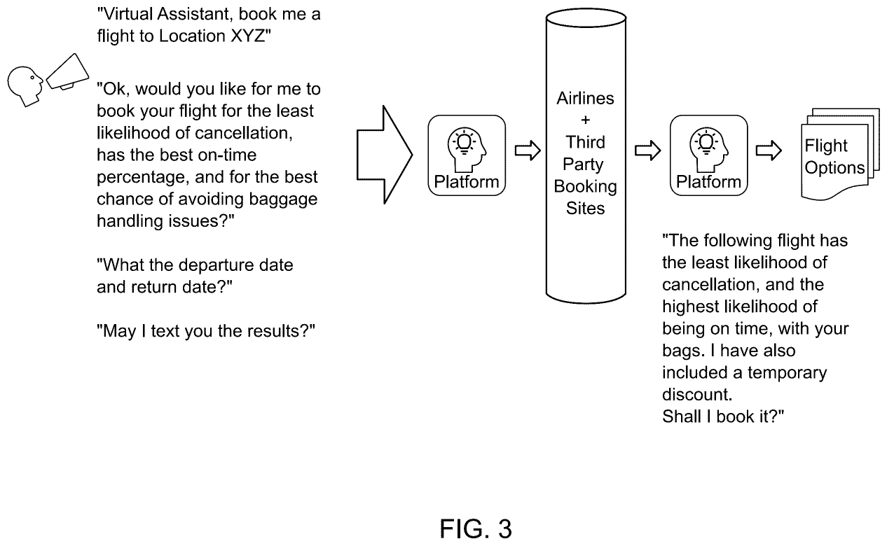

As illustrated in FIG. 3, a particularly desired feature of the present invention for the mobile application is to enable users to interact with a virtual assistant present on the user device to issue verbal requests or commands to perform various functionalities, such as requesting flight bookings, changing existing flight bookings, canceling existing flight bookings, and the like, whereby the virtual assistant then interacts with the present invention to generate and present to the user multiple options corresponding to airlines with the most favorable user experience metrics as determined by the system of present invention. References to the user interface and to various functionalities of the present invention throughout should be understood to apply similarly to the web platform and mobile application.

A core functionality of the present invention is to collect data from consumers regarding their previous flights, analyze said data, and present prospective consumers with results of the analysis to assist them in their decision-making process for booking flights.

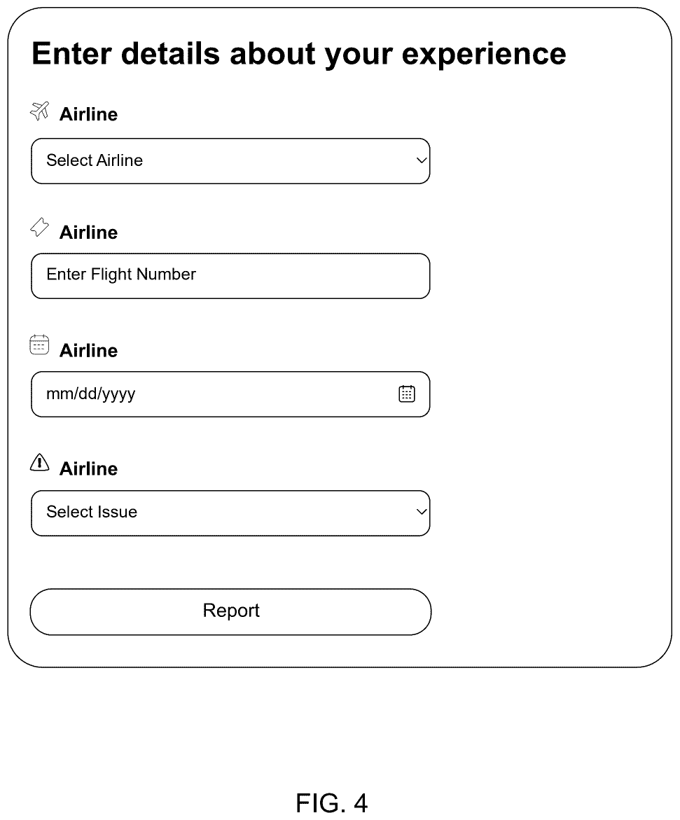

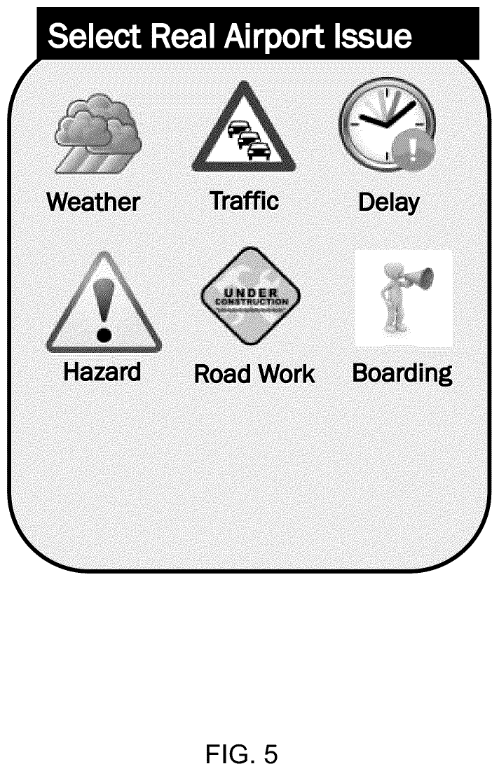

To this end, in the contemplated embodiment, the user interface is configured to receive consumer input relating to airline service experiences based on a plurality of metrics concerning airline service experiences. More particularly, in an exemplary embodiment, the user navigates to the URL address of the web platform or a relevant section of the mobile application, navigates to a “Report Incident” page or clicks a button to that effect, and is presented with a menu, form or some other digital input means to record an incident with the system, examples of which are shown in FIGS. 4 and 5. Such incidents may include, for example, canceled flights, late flights, lost or mishandled baggage, or issues with obtaining a refund. Relevant information may be entered, such as, but not limited to, date of issue, type of issue, flight number, a numerical quantity characterizing the nature of the incident (e.g., 40-minute delay, two out of three baggage items lost, etc), and the like. Any suitable user input element may be utilized, including, but not limited to, dropdown menus, text input fields, calendar selection menus, radio buttons, graphical icon selections, sliders, checkboxes, and the like. In other embodiments directed toward other industries or applications, the user interface may be configured to receive user input corresponding to various other relevant information items.

Once the relevant information is inputted by the user through the user interface and received by the system, the consumer input is stored in the database. At scale and over time, many such consumer inputs are received and stored. This collection of user experience reports constitutes crowdsourced evaluation data for multiple airlines. The use of this crowdsourced data is the primary feature of the present invention that underpins and enhances its other features. In the contemplated embodiment, the plurality of metrics includes, but is not limited to, factors relating to on-time performance, frequency of cancellations, baggage handling efficiency, and the speed and reliability of refund processing. These metrics capture various aspects of air travel commonly contributing to less than satisfactory travel experiences. Comparative assessments of various airlines based upon these metrics augments the ability of prospective travelers to make informed travel choices. In other embodiments, as mentioned, different metrics may be captured to perform comparative assessments as relevant to various specific implementations.

Generally, throughout the present disclosure, a singular database will be referred to for storing various information. However, it should be understood that in real-world implementations and various embodiments, multiple databases may be utilized for various specific purposes. For example, in a contemplated embodiment, the present invention may comprise multiple databases for capturing consumer input. These databases may include, but are not limited to, a cancellation database, an on-time database, a baggage database, and a cancellation time to refund database, configured to store data corresponding to those categories of consumer input received through the user interface. In some embodiments, captured data may be considered obsolete and removed after a specified period of time, for example 60 days.

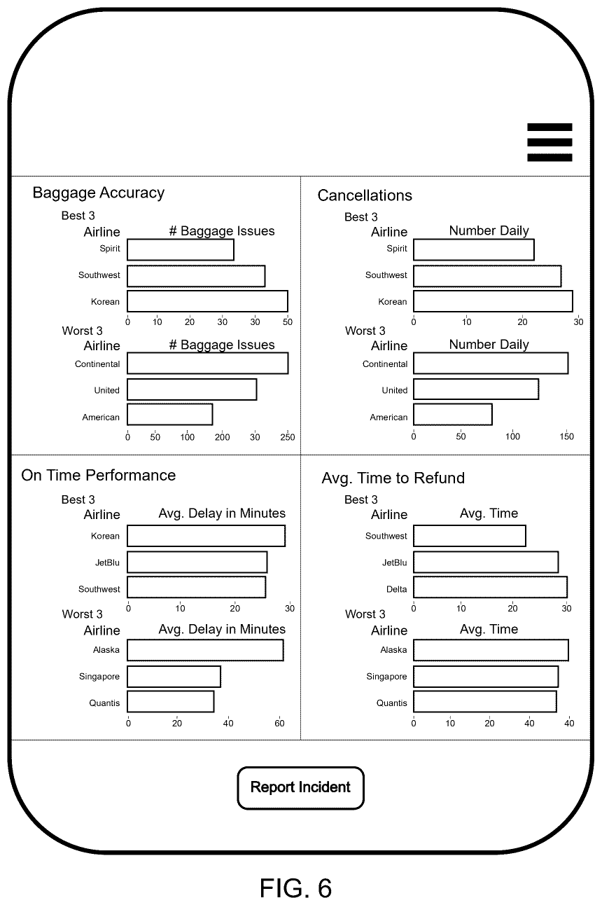

The user interface is further configured to display a public dashboard displaying evaluations of different airlines, the evaluations being derived from performance assessments calculated by the AI system. The public dashboard is designed to be intuitive and user-friendly, offering visual representations of airline evaluations. The public dashboard serves as a central feature for users to assess and compare the performance of various airlines in order to make informed booking decisions. An exemplary public dashboard is depicted in FIG. 6, wherein four different metrics are simultaneously displayed for comparison among various airlines. The exemplary public dashboard of FIG. 6 further displays rankings of the best and worst performing airlines for each metric.

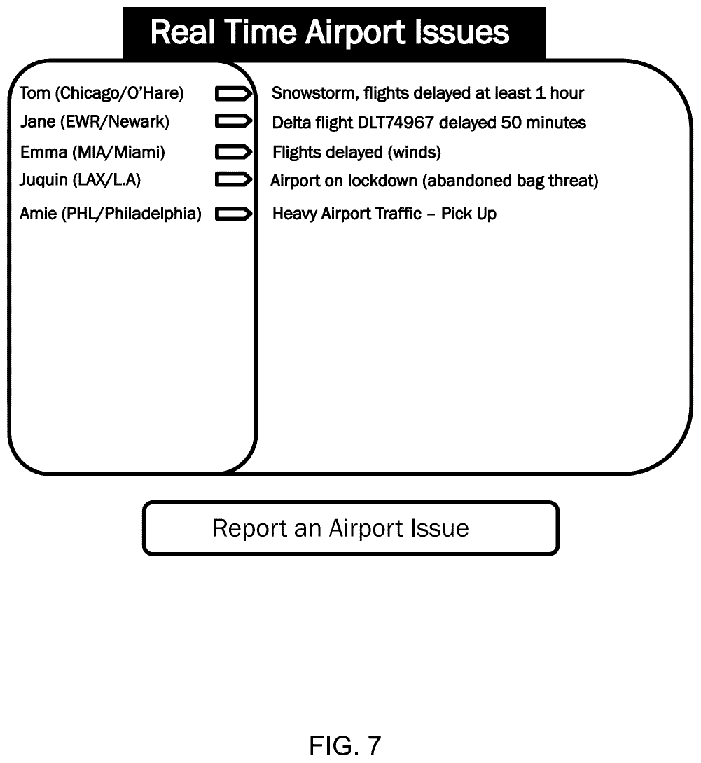

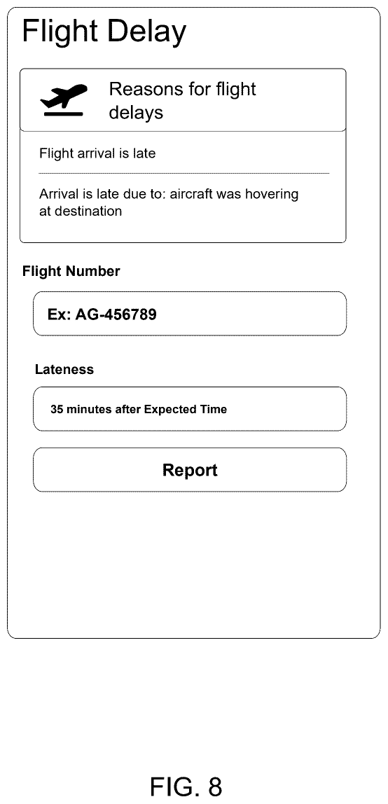

It should be well understood that the specific configuration of the public dashboard may vary in different embodiments, and is not limited to the aforementioned structure and information content. The web platform and mobile application of the present invention are preferably configured to further display various other relevant information, including, but not limited to, a dashboard or other display for up-to-date delays and other issues with current flights, as depicted in FIG. 7, and individual displays for specific flight delays for displaying specific information, as depicted in FIG. 8. In different embodiments directed toward other industries or various other implementations, the present invention may be configured to generate and display one or more dashboards configured to present various configurations of collected data as suitable to the specific implementations.

The AI system within the web platform is a critical aspect of the present invention, being configured to analyze the consumer input, or crowdsourced evaluation data, stored in the database and generate performance assessments therefrom for a plurality of airlines or other entities. The performance assessments are calculated from the metrics captured in the consumer input. Moreover, the performance assessments are responsive to reception of new data as new consumer input is received. The AI system continually, or at predetermined internals, recalculates the performance assessments including new data, thereby maintaining an ongoing current assessment of the various airlines' service performance.

Correspondingly, the web platform is further configured to publish and regularly update the performance assessments on the public dashboard. This ensures that the evaluations remain temporally relevant and reflective of the latest consumer input and metrics.

In addition to these functionalities, the web platform is configured to facilitate selection and booking of air travel for a user based on a request received via the user device. This selection and booking process is governed or enhanced through the AI system, which seeks to optimize the process for the benefit of the user, incorporating the most recent performance assessments to guide the decision-making process. In some embodiments and instances, additional data regarding the user's habits, preferences, or other attributes may be acquired through various means and incorporated in the optimization process, further aiding in selecting an optimal air travel booking for the user making the request. It should, of course, be well understood that the activity the present invention is primarily configured to facilitate may vary in different embodiments according to various different specific implementations.

To this end, in the contemplated embodiment, the web platform is further configured to interact with a virtual assistant on the user device, such as Google Assistant, Apple's Siri or similar technology, as broadly illustrated in FIG. 3. The user can conveniently engage with the virtual assistant to express travel preferences, inquire about flight options, initiate the booking process, or other functionalities. As discussed throughout, the general concept and process of this interaction between the user and virtual assistant may further be broadly applied to other industries and implementations than airline travel booking.

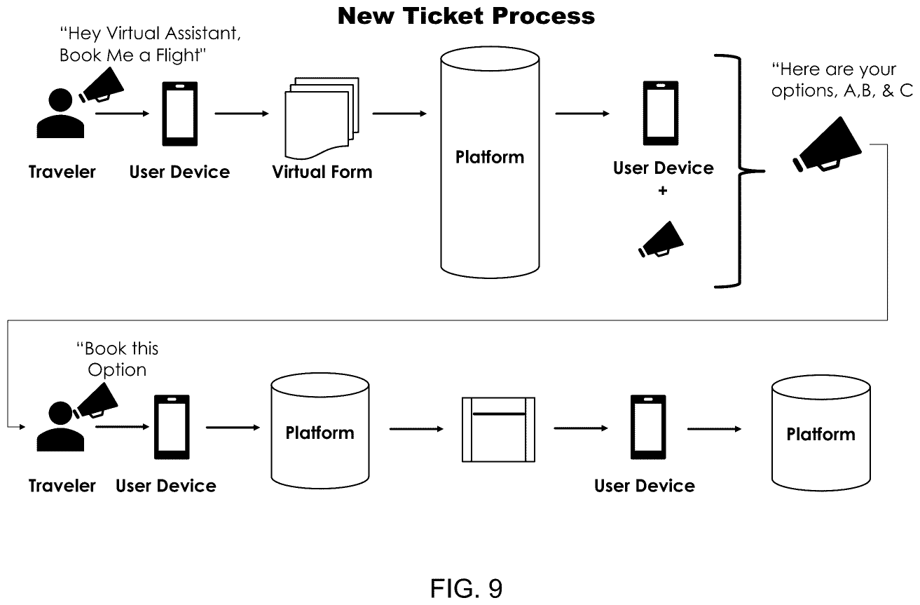

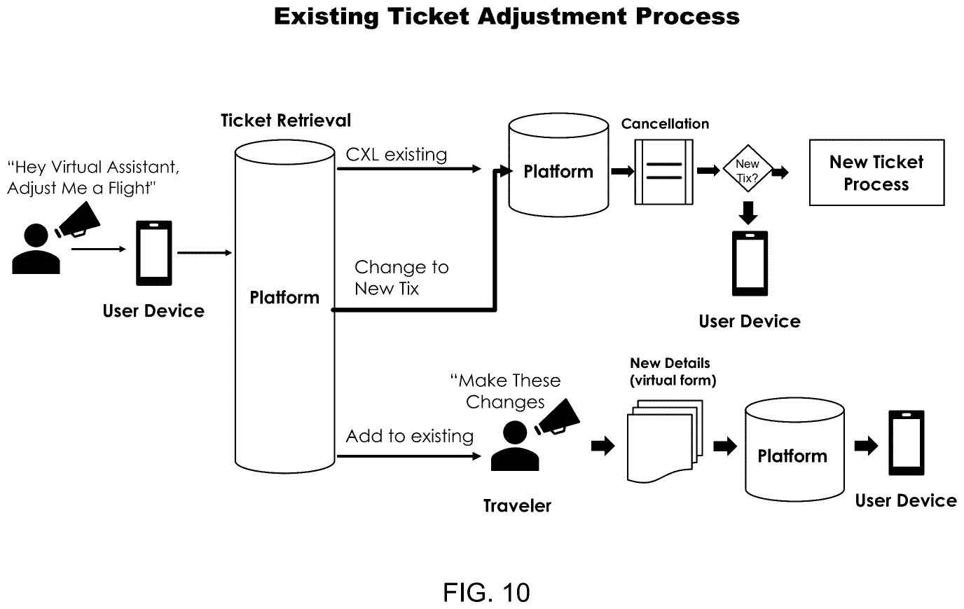

FIG. 9 depicts a general process flow for booking a new air travel ticket through the present invention through verbal user interaction with the virtual assistant on their mobile device. Upon receiving a booking request through the virtual assistant, the web platform retrieves air travel information from one or more booking entities, such as airline databases, travel agencies, or online travel booking platforms. The AI system processes the retrieved information to determine one or more optimized booking options based on the performance assessments, and in some embodiments additionally incorporating individual user data such as preferences, habits, and the like, and the optimized booking options are transmitted to the virtual assistant for display to the user on the user device. Various additional functionalities may be facilitated through interaction with the virtual assistant as desired. For example, FIG. 10 depicts a general process flow for making adjustments to an existing ticket booking.

A significant feature of the present invention considered broadly applicable to many industries and applications is the voice recognition aspect of the user's communication with the AI system. As previously discussed, the AI system is configured to interact with the user through voice commands to provide a convenient hands-free user experience. However, it should be noted that, in its preferred embodiment, this is not limited to a simple, single-step process, but can be realized into an iterative, multi-step process. The AI system prompts the user for additional input as needed, refining the process flow based on user responses, continuing this back-and-forth interaction to achieve a result that is substantially more optimal and tailored to the user's particular needs than a simple response to a singular query.

Another feature enabled by the present invention is that the web platform is further configured to identify and apply relevant coupon codes for air travel bookings while facilitating the optimized selection and booking of air travel for a user via the user device. Additional types of discounts may be used in this feature as well, including rebates or other discount modifiers. The coupon codes or other discounts may be retrieved from any applicable source and automatically incorporated into the booking process to provide discounted air travel options to the user as part of the optimization.

In the contemplated embodiment, the present invention further enables the web platform to dynamically adjust airfares during the booking process. This adjustment is based on the performance assessments generated by the AI system. The dynamic pricing model responds to real-time changes in various factors, such as consumer demand, flight availability, and the performance metrics of airlines. For example, if an airline experiences a negative trend in their performance assessments, their flights may be reduced in cost as a consumer incentive to offset any potential associated decrease in bookings. This feature allows the web platform to offer up-to-date and competitive pricing to users, aligning airfare costs with the current market and performance conditions.

In a preferred embodiment of the present invention, the following functional requirements are implemented. Travel preferences, including but not limited to an airport preference and preferred departure and arrival times are stored in the database associated with the user profile. The travel preferences may be recorded through user input or automatically determined through analysis of a travel history associated with the user profile, or through other appropriate means. Moreover, an individual travel profile is built for the user profile with a travel history. The airport preference is recorded into the travel profile with history, local to the user device, and the airport preference is stored in the database of the present invention.

Another functional requirement is integration of the virtual assistant with the flight aggregator functionality of the present invention. For example, the following steps may be followed: (1) verbal information is retrieved through the user device (2) verbal information populates a virtual form (3) flight options are generated from the flight aggregator (4) the list of options produced by the flight aggregator is narrowed to the top three results (5) the user device audibly reviews or otherwise discloses the top two selections with approved dialogue (6) actionable response is retrieved (7) an executable, or interactable web page is delivered to the user device.

Another functional requirement is to create a calendar event with flight information, including, but not limited to date flight booked, destination, departure time, arrival time, number of days for the trip, airline, and airport.

Another functional requirement is closing dialogue to retrieve future information. For example, the virtual assistant may audibly speak through the user device “If you like, I can look for airfare sales to your next destination over the next several months. Is there a future destination or holiday travel that where you want me to find the lowest price?” Subsequently, a verbal response is received from the user, and the destination, travel date, and return date if the travel is a round trip are recorded. The virtual assistant may then speak a response such as “Great, I'll look for air travel deals throughout the day, each day and notify you when I find a couple of great travel options.” The future destination details are stored in a future travel database, which may be local to the user device, and to a database of the system of the present invention corresponding to intended travel.

Another functional requirement involves the consideration of delivering push notifications to the user device, particularly (1) negotiated fare the system negotiates with an airline and (2) conditions matching local stored travel information. The system matches future travel destinations to airfare sales, including matching future travel needs to airfares negotiated by the system with airlines.

FIG. 9 depicts a method of use 101 for the system of FIGS. 1-10 in accordance with an embodiment of the present invention. The method 101 initiates with step 103 of providing up a web platform that is communicably coupled with a database and configured to manage an AI system.

The method 101 then proceeds to step 105, where consumer input based on a plurality of metrics is received relating to airline service experiences from a user device via a communication network. The received consumer input is then stored in the database 107.

Subsequently at 109, the AI system analyzes the stored consumer input to generate performance assessments for a plurality of airlines, the assessments being derived from the metrics embedded within the consumer input. The performance assessments are continually updated 111, incorporating new consumer input as it is received.

At step 113, the method 101 includes displaying of a public dashboard on the web platform. This dashboard features evaluations of different airlines, with these evaluations being rooted in the performance assessments calculated by the AI system. The performance assessments are regularly updated on the public dashboard 115 to maintain the relevance and accuracy of the information displayed.

Finally, in step 117, the method facilitates the selection and booking of air travel for users. This process is based on requests received from the user device and is informed by the most recent performance assessments generated by the AI system.

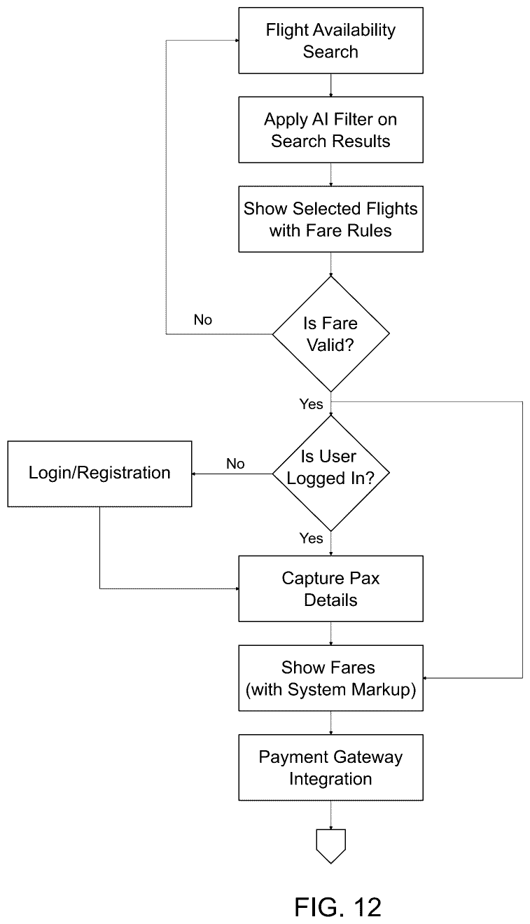

FIGS. 12-17 depict various specific implementations of process flows for various functionalities of the present invention in various embodiments.

FIG. 12 is a flow diagram depicting a specific process flow for general booking in an embodiment of the present invention. The process begins with a flight availability search, followed by the application of an AI filter on search results to show selected flights with fare rules. The system then determines if the fare is valid. If not, the process ends. If the fare is valid, the system checks if the user is logged in. If the user is not logged in, the process requires login or registration. Once logged in, the system captures passenger details, shows fares with system markup, and integrates with the payment gateway to complete the booking.

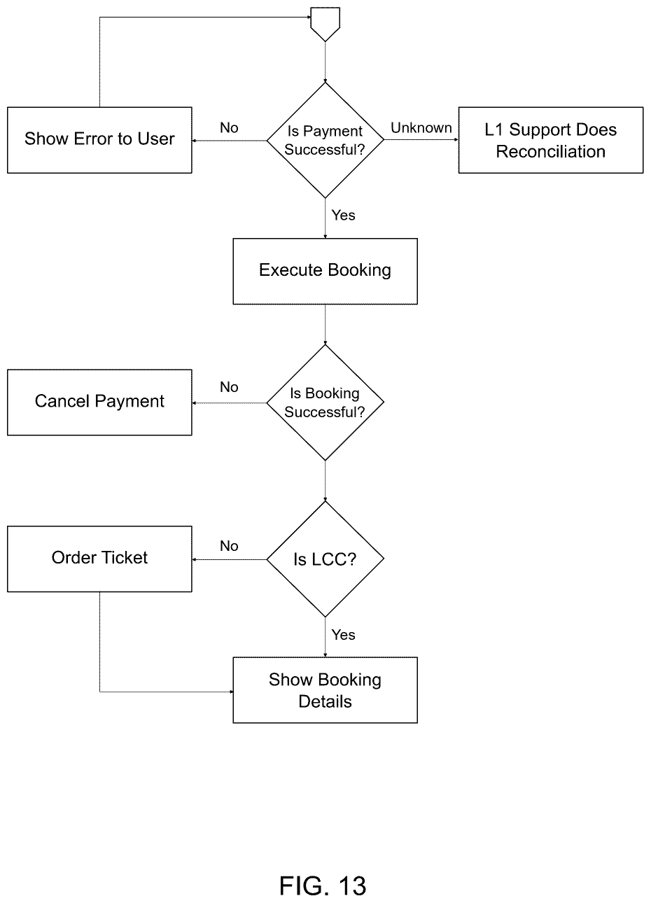

FIG. 13 is a continuation of FIG. 12. After payment, the system verifies if the payment was successful. If unsuccessful, an error is shown to the user. If payment status is unknown, L1 support handles reconciliation. Upon successful payment, the system executes the booking. If the booking is unsuccessful, the payment is canceled. If the booking is successful, the system checks if the airline is a low-cost carrier (LCC). If not an LCC, the ticket is ordered, and booking details are shown. If it is an LCC, booking details are directly shown.

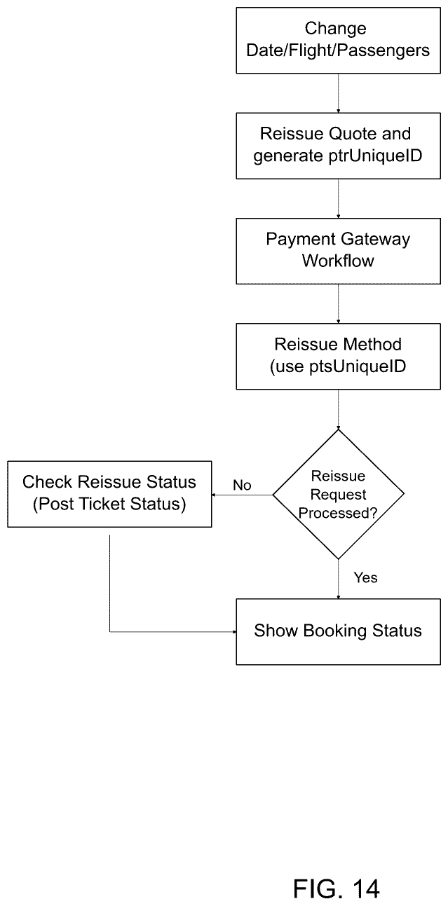

FIG. 14 is a flow diagram depicting a specific process flow for processing adjustments to existing bookings in an embodiment of the present invention. The process begins with changes to date, flight, or passengers, followed by reissuing a quote and generating a unique identifier. The system then follows the payment gateway workflow, reissue method using the unique identifier, and checks the reissue status. If the reissue request is processed, the system shows the updated booking status.

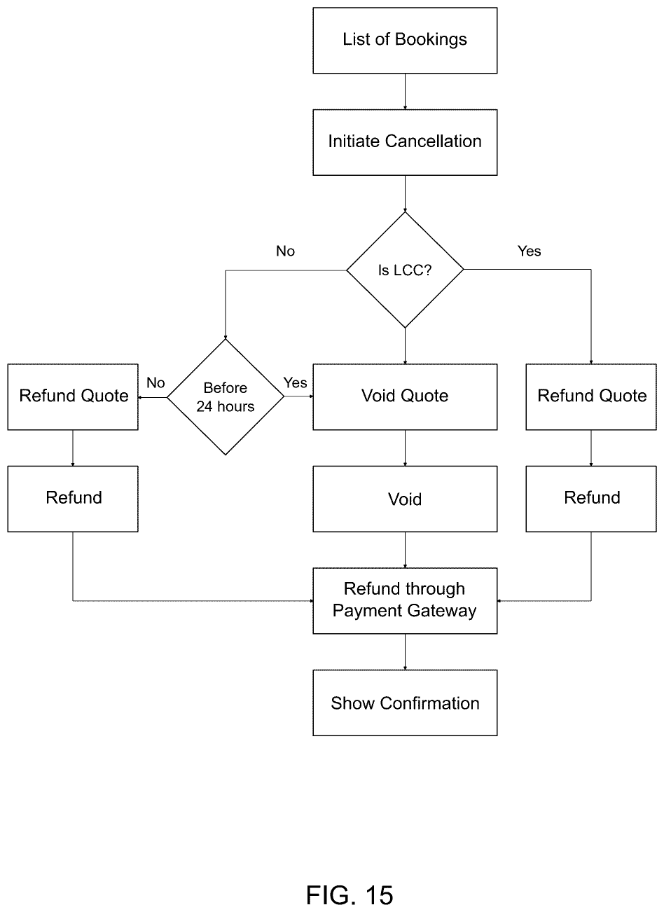

FIG. 15 is a flow diagram depicting a specific process flow for processing booking cancellations by passengers in an embodiment of the present invention. The process starts with a list of bookings, followed by initiating cancellation. The system checks if the airline is an LCC. If not an LCC, it provides a refund quote. If the cancellation is before 24 hours, it proceeds with a refund. If after 24 hours, the system voids the refund quote. If the airline is an LCC, the system directly voids the quote. The refund is processed through the payment gateway, and a confirmation is shown.

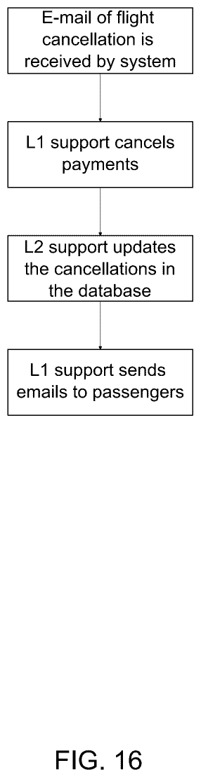

FIG. 16 is a flow diagram depicting a specific process flow for processing booking cancellations by airlines in an embodiment of the present invention. The process begins with the system receiving an email of flight cancellation. L1 support cancels payments, and L2 support updates the cancellations in the database. Finally, L1 support sends emails to passengers informing them of the cancellation.

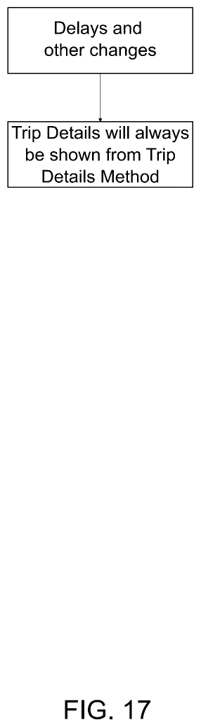

FIG. 17 is a flow diagram depicting a specific process flow for communicating delays and other booking changes in an embodiment of the present invention. The system provides updates on delays and other changes, ensuring that trip details are always shown from the trip details method.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for optimizing user selection of purchase options comprising:
a web platform communicably coupled with a database and configured to manage an artificial intelligence (AI) system; and
a user interface within the web platform accessible from a user device via a communication network, the user interface being configured to:
receive consumer input relating to user experiences based on a plurality of metrics and store the consumer input in the database; and
display a public dashboard of entity evaluations, wherein the evaluations are based on performance assessments calculated by the AI system;
the AI system being configured to:
analyze the consumer input; and
generate and update performance assessments for a plurality of entities based on the metrics and new consumer input;
the web platform being further configured to:
publish and regularly update the performance assessments on the public dashboard; and
facilitate optimized selection and purchase of options based on a user request received via the user device.

2. The system of claim 1, wherein the user experiences are airline service experiences; wherein the entity evaluations are airline evaluations; and wherein the purchase options are air travel bookings.

3. The system of claim 2, wherein the web platform is further configured to:
interact with a virtual assistant on the user device to process an air travel booking request received by the virtual assistant;
retrieve air travel information from one or more booking entities in response to the booking request;
process the retrieved information using the AI system to determine one or more optimized booking options based on the performance assessments; and
transmit the optimized booking options to the virtual assistant.

4. The system of claim 2, wherein the metrics relate to on-time performance, frequency of cancellations, baggage handling, and speed of refund processing.

5. The system of claim 2, wherein the web platform is further configured to:
identify and apply relevant coupon codes for air travel bookings; and
automatically incorporate the relevant coupon codes into the booking process to provide discounted air travel options to the user as part of the optimization.

6. The system of claim 2, wherein the web platform is further configured to dynamically adjust airfares during the booking process based on the performance assessments.

7. A computer-implemented method for optimizing service selection, the method comprising the steps of:
providing a web platform communicably coupled with a database and configured to manage an artificial intelligence (AI) system;
receiving consumer input relating to user experiences from a user device via a communication network, wherein the consumer input is based on a plurality of metrics;
storing the received consumer input in the database;
analyzing the consumer input using the AI system to generate performance assessments for a plurality of entities;
updating the performance assessments based on new consumer input;
displaying a public dashboard of entity evaluations on the web platform, wherein the evaluations are based on the performance assessments;
regularly updating the performance assessments on the public dashboard; and
facilitating optimized selection and booking of services based on a user request received from the user device.

8. The system of claim 7, wherein the user experiences are airline service experiences; wherein the entities are airlines; and wherein the services are air travel bookings.

9. The method of claim 7, further comprising the steps of:
interacting with a virtual assistant on the user device to process a booking request received by the virtual assistant;
retrieving service information from one of more booking entities in response to the booking request;
determining one or more optimized booking options using the AI system based on the performance assessments; and
transmitting the optimized booking options to the virtual assistant.

10. The method of claim 8, wherein the plurality of metrics relate to on-time performance, frequency of cancellations, baggage handling, and speed of refund processing.

11. The method of claim 8, further comprising the step of automatically identifying and applying relevant coupon codes to air travel bookings to provide discounted air travel options to the user as part of the optimization.

12. The method of claim 8, further comprising the step of dynamically adjusting airfares during the booking process based on the performance assessments.
